(19) United States
(12) Patent Application Publication
(10) Pub. No.: US 2025/0094611 A1
(43) Pub. Date: Mar. 20, 2025

(54) PROTECTING SENSITIVE DATA USED BY LARGE LANGUAGE MODELS

(71) Applicant: Acronis International GmbH, Schaffhausen (SG)

(72) Inventors: Serg Bell, Costa del Sol (SG); Stanislav Protasov, Singapore (SG)

(21) Appl. No.: 18/469,083

(22) Filed: Sep. 18, 2023

(51) Int. Cl. G06F 21/62

(52) U.S. Cl. CPC G06F 21/62

(57) ABSTRACT

Systems and methods for protecting certain personal data used by large language models. A user can ask artificial intelligence to provide an answer that can include personal or sensitive data. Systems and methods determine which data is restricted and personal, and which data is not. Personal or sensitive data is handled according to handling rules.

### TECHNICAL FIELD

Embodiments relate generally to large AI models. More particularly, embodiments relate to protecting sensitive data used by large AI models.

### BACKGROUND

A large language model (LLM) is a trained deep-learning model that understands and generates text in a human-like fashion. LLMs such as ChatGPT have emerged as useful tools that human users can interact with to refine and steer a conversation towards a desired length, format, style, level of detail, and language used. Effectively, ChatGPT is an AI chatbot that uses natural language processing to create humanlike conversational dialogue.

Certain LLMs utilize personal data as part of their training to build a model. For example, millions of pages scraped from the Internet, books, and more are used to create generative text systems. This data can include personal information associated with an identifiable person, and can be presented to users of the LLM. Further, users often submit personal information to the LLM as part of their conversation. For example, a user can instruct a chatbot, “here is a scan of my passport, please extract the data and fill out these forms.”

The use of personal data by LLMs is dangerous. For example, personal data can be used to retrain an LLM, which can result in the leaking of personal data to others without the user's consent. The sharing of personal data with others puts the identified person or owner of sensitive data at risk, including personal safety risk, identify theft risk, and financial identity theft risk. Further, the use of personal data by LLMs can be illegal. Europe's General Data Protection Regulation (GDPR) rules cover the way organizations collect, store, and use people's personal data. According to the GDPR, personal data can be anything from a person's name, address, email address, to their IP address. If the data can be used to identify someone, it can count as personal information. Certain countries have even issued orders banning certain generative AI models due to their use of personal information. Accordingly, the operators of certain AI models are at legal risk due to the use of personal information. Moreover, beyond certain laws or regulations, individual users can object to the use of their personal or sensitive information.

Therefore, there is a need for improved handling of data in large language model processing.

### SUMMARY

Embodiments described or otherwise contemplated herein substantially meet the aforementioned needs of the industry. Embodiments described herein protect certain data used by large language models.

As used herein, the terms “personal data,” “personal information,” “personally identifiable information (PII),” “sensitive data,” and similar language do not reference any particular definition (e.g. associated with laws of particular jurisdiction), but rather are used interchangeably to mean data related to an identifiable person and can include data that is personal, sensitive, or otherwise identified according to user preference.

In a feature and advantage of embodiments, personal data is handled in compliance with multiple jurisdictions across cloud storage. In particular, embodiments account for the different personal data compliance frameworks in storing, transmitting, or presenting data. For example, engines can selectively handle personal data according to a first protocol for a first location on a network and handle personal data according to a second protocol for a second location on the network. Likewise, local storage can be handled according to, for example, a third protocol. Embodiments can be dynamically updated based on local rules via implementation of a dynamically updatable handling module.

In another feature and advantage of embodiments, data retention policies are implemented and dynamically adapted based on artificial intelligence. For example, a machine learning model can be trained and subsequently learn that data can be stored in a first relative location, but not in a second relative location (e.g. by IP address or other locator).

In another feature and advantage of embodiments, data is marked (e.g. labeled). Data and associated labels are used to protect the data by handling data according to the label. In an embodiment, data, associated labels, and actual handling of the data can be used to further train machine learning models. In an embodiment, data can be marked upon detection at any stage of the user-AI model interaction; such as when receiving personal data, when the AI model retrieves personal data, when transmitting personal data, or when potentially issuing personal data.

In another feature and advantage of embodiments, users can be prevented from storing data having personal information. In an embodiment, a user can be presented the opportunity to modify or destroy the data upon detection of personal data. In an embodiment, a user can be warned about the use of personal data. In an embodiment, a handling module can blur or otherwise obstruct personal data.

In another feature and advantage of embodiments, personal data can be detected in streaming input. For example, data received by a user or retrieved by an AI model. Further, personal data can be detected in storage, such as labeled or unlabeled storage.

In an embodiment, a method for protecting sensitive data comprises generating a rule set for handling sensitive data; receiving, via a natural language processing tool, a request from a user; retrieving data associated with the request, wherein the data includes at least one of text data, image data, video data, audio data, virtual reality data, or gesture data; determining a sensitive data portion of the data; labeling the sensitive data portion of the data; operating on the sensitive data portion according to the rule set based on the labeling to generate modified data; and returning the modified data to the user.

In an embodiment, a system for protecting sensitive data comprises computing hardware of at least one processor and memory operably coupled to the at least one processor; and instructions that, when executed on the computing hardware, cause the computing hardware to implement: a natural language processing tool configured to receive a request from a user, a data management engine configured to retrieve data associated with the request and label sensitive data portion of the data, wherein the data includes at least one of text data, image data, video data, audio data, virtual reality data, or gesture data, a detection engine configured to determine a sensitive data portion of the data, a handling engine configured to generate a rule set and operate on the sensitive data portion according to the rule set based on the labeling to generate modified data, and wherein the natural language processing tool is further configured to return the modified data to the user.

In an embodiment, a machine learning model trained on training data of a plurality of previous natural language requests including a plurality of previous sensitive data, the machine learning model configured to: receive a natural language request from a user; determine data associated with the request; determine a sensitive data portion of the data; determine a handling instruction for the sensitive data portion; and return the sensitive data portion to the user according to the handling instruction.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for protecting data used by an AI model, according to an embodiment.

FIG. 2 is a block diagram of a system for protecting data used by an AI model, according to an embodiment.

FIG. 3 is a block diagram of cloud storage across multiple physical jurisdictions, according to an embodiment.

FIG. 4 is a flowchart of a method for protecting data used by an AI model, according to an embodiment.

FIG. 5 is a flowchart of a method for protecting data used by an AI model, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

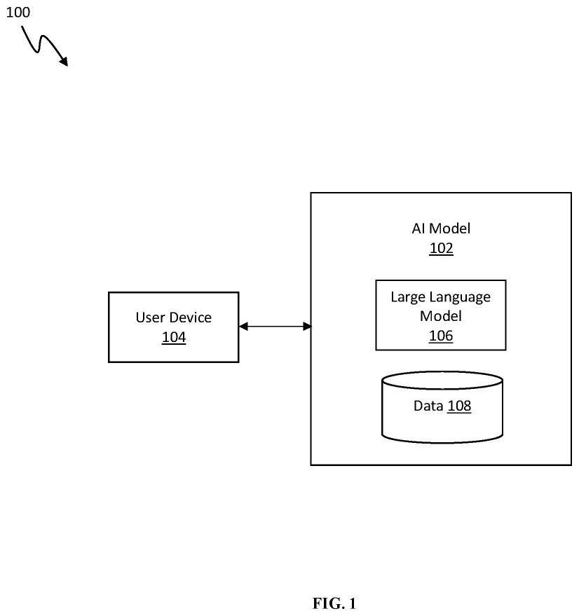

Referring to FIG. 1, a block diagram of a system 100 for protecting data used by an AI model, according to an embodiment. System 100 generally comprises an AI model 102 and a user device 104.

In context, in the process of network communication, a user can ask AI to provide an answer, receive valuable data, such as the text of a contract, or an image of a document with data, or an image with my address or other biometrics (3D printer, etc.). Embodiments determine which data is restricted and personal, and which data is not. Further, this personal data is stored in compliance with the GDPR or other requirements, including cross-border transfer, which is broken down into data processing in the cloud center (computing without storage) and storage, including file storage.

Embodiments described herein includes various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

AI model 102 is configured with a trained deep-learning model that understands and generates responses in a human-like fashion. In an embodiment, AI model 102 can include a large language model (LLM) 106 and at least one data repository 108. For example, AI model 102 can be a chatbot. In another example, AI model 102 can be a multimodal fusion subsystem. In other examples, AI model 102 can be configured for text conversations, audio conversations, video conversations, virtual reality (VR) conversations, gesture conversations, or any other suitable visible interaction mode.

LLM 106 can comprise a pre-trained large language model. For example, LLM 106 can include an artificial neural network (ANN) having many parameters trained on large quantities of text, images, audio, video, gestures, or other types of data. In embodiments, training can include self-supervised learning, semi-supervised learning, or unsupervised learning. In an embodiment, LLM 106 can be trained for natural language processing. In an embodiment, LLM can be trained on human user interactions. As used herein, the term “LLM” can include a large language model. Further, “LLM” can further include multimodal models including models not just trained on language, but can also include images, audio, or other inputs (e.g. converted to an internal representation for training purposes).

Data repository 108 can include training data on which LLM 106 is trained or pre-trained. In an embodiment, data repository 108 can include data from which LLM 106 can use to interact with a user. In an embodiment, data repository 108 can include temporary or permanent storage of data submitted by a user interfacing with AI model 102.

User device 104 is a computing device operable by a human user. For example, user device 104 can include a desktop computer, a laptop computer, tablet, or mobile computing device. In embodiments, user device 104 is configured to communicate with AI model 102 based on user commands (e.g. to engage in a natural language conversation). Accordingly, user device 104 can be communicatively coupled to AI model 102.

In operation of system 100, a user operates user device 104 to interact with AI model 102. AI model 102, using LLM 106 and at least one data repository 108, interprets the user interactions and provides responses to the user through user device 104.

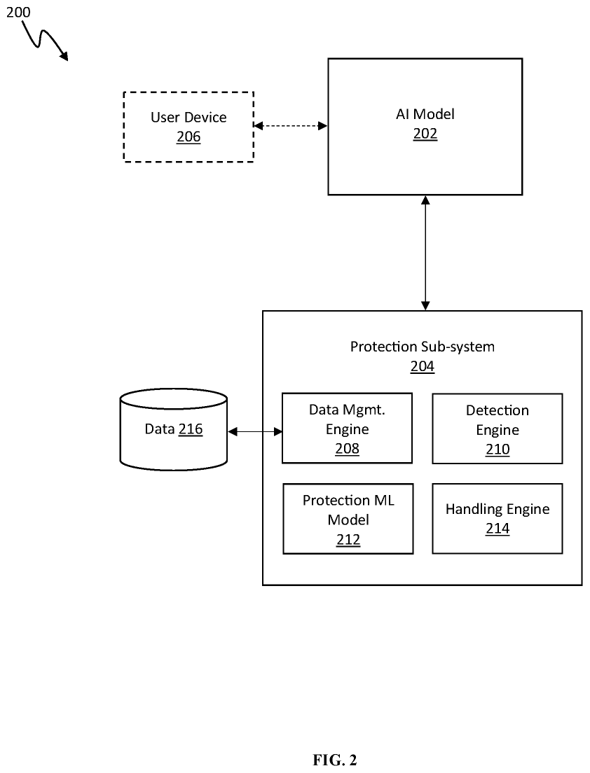

Referring further to FIG. 2, a block diagram of a system 200 for protecting data used by an AI model is depicted, according to an embodiment. System 200 can be implemented as part of AI model 102. More particularly, in operation of system 200, sensitive data operated on by an AI model is protected.

System 200 generally comprises an AI model 202 and a protection sub-system 204. As further depicted in FIG. 2, a user device 206 can interface with AI model 202. User device 206 can be substantially similar to user device 104 as depicted in FIG. 1. In an embodiment, AI model 202 can include components of AI model 102, such as LLM 106 and data repository 108. In other embodiments, as will be described, components of AI model 102 are integrated with or included as part of protection sub-system 204.

Protection sub-system 204 generally comprises a data management engine 208, a detection engine 210, a protection machine learning (ML) model 212, a handling engine 214, and at least one data repository 216.

Data management engine 208 is configured to operate on data related to AI model 202. In an embodiment, data management engine 208 is configured to store and retrieve data. In an example, data management engine 208 is configured to receive a data request from AI model 202 and retrieve the requested data. For example, data management engine 208 can receive a data request as interpreted by AI model 202 from the user of user device 206, and retrieve data that AI model 202 believes to be associated with the user interaction. In an embodiment, data management engine 208 is configured to store data transmitted by the user via user device 206.

In an embodiment, data management engine 208 is further configured to label data for data repository 216. For example, if non-labeled data is identified as sensitive (e.g. by detection engine 210), the data can be subsequently labeled as sensitive in data repository 216 by data management engine. Data management engine 208 can label data at any time during data handling. For example, data can be labeled upon receipt from the user. In another example, data can be labeled after retrieval instructed by AI model 202. In another example, data can be labeled upon potential issuance or potential to the user. In another example, unlabeled data in data repository 216 can be retrieved by data management engine 208 and subsequently labeled, for example after a command to retrieve certain data by AI model 202, or during AI model 202 down time (e.g. data management engine 208 can “catch up” on data stored in repository 216 but not labeled).

In an embodiment, data management engine 208 is configured to label data according to different levels of sensitivity. For example, various levels can include a first level of data not compliant with GDPR, a second level not compliant with Country X, and a third level of general sensitivity, and a fourth level of user-specific sensitivity. In embodiments, hierarchies of personal data or sensitivity can be labeled such that handling engine 214 can use the data according to those hierarchies.

As illustrated in FIG. 2, data management engine 208 is communicatively coupled to data repository 216. As will be described, data management engine 208 is configured to operate on labeled data associated with AI model 202. In an embodiment, labeling is used to protect certain data (e.g. where labeled as sensitive and according to relevant handling instruction).

Detection engine 210 is configured to determine sensitive data related to AI model 202. For example, detection engine 210 can determine all or portions of the data retrieved by data management engine 208 include sensitive data. In another example, detection engine 210 can determine all or portions of the data received by the user includes sensitive data.

More particularly, detection engine 210 utilizes a machine learning model to determine sensitive data. In an embodiment, sensitive data can be defined using the machine learning model. As illustrated in FIG. 2, detection engine 210 is configured to utilize protection ML model 212. Protection ML model 212 can include an artificial neural network (ANN) having many parameters trained on large quantities of text, images, audio, video, gestures, or other types of data. In embodiments, training can include self-supervised learning, semi-supervised learning, or unsupervised learning. In another embodiment, detection engine 210 utilizes sensitive data as defined by a user, or by other labeling or input. For example, data taken from a sensitive source can be determined to include all sensitive data.

Referring again to the embodiment in FIG. 2, in which detection engine 210 utilizes a machine learning model (protection ML model 212) to determine sensitive data, in embodiments of training based on images, protection ML model 212 can be configured with optical character recognition or other image recognition or machine vision elements for subsequent identification of personal data in images.

In an embodiment, protection ML model 212 is trained to detect sensitive data. In one example, protection ML model 212 can comprise a pre-trained large language model. In an embodiment, detection engine 210 can generate protection ML model 212 using a training dataset of known personal data. For example, detection engine 210 can use a training dataset of user requests, data retrieved as part of user requests, and so on. In an embodiment, such features are represented as a feature vector. In an embodiment, labeling (e.g. from data in data repository 216) is used to train one or more machine learning models, such as protection ML model 212.

In an example, protection ML model 212 can be trained based on the specific definition of the data intended to be identified. In one example, specific models such as protection ML model 212 can be trained to exclude data or dictionaries depending on the definition of sensitive data (e.g. legal definition, user preference definition, and so on). In another example, specific data for a user can be assumed to prevent usage. For example, in the case of data related to the former employer of a user, accidental usage of such data can be filtered. In another example, in the case of data detected to have certain language such as data not suitable for certain individuals, such data can be filtered (e.g. ethical, principled, or other controversial data).

In an embodiment, detection engine 210 can retrain protection ML model 212 based on actual requests from user device 206 and actual data handling by protection sub-system 204. In this way, a feedback loop to protection ML model 212 using actual data improves the sensitive data detection abilities of protection ML model 212. In an embodiment, detection engine 210 can communicate to the user via user device 206 to request if the personal data of the user can be used in training protection ML model 212. Accordingly, protection ML model 212 can be retrained based on the user's answer to the request (e.g. train based on the user's personal information if accepted, not train based on the user's personal information if declined, train based on genericized personal information, etc.)

In an embodiment, protection ML model 212 can comprise a series of cascading models. For example, a first model in the series can be trained to detect the most sensitive data. A second model in the series can be trained to detect intermediate sensitive data. A third model in the series can be trained to detect lowest level sensitive data. In other embodiments, a series of cascading models can be used to correspond to the personal data protections of individual jurisdictions where the data may be stored, operated on, or sent.

In one embodiment, AI model 202 and protection ML model 212 can comprise a single model such that AI model 202 itself can detect sensitive data (e.g. as utilized by detection engine 210).

In embodiments, detection engine 210 in coordination with protection ML model 212 can detect and identify all sensitive information relating to a user. Though not depicted in FIG. 2, detection engine 210 can implement separate monitors including a file monitor, a network monitor, and a user experience (UX) monitor, a user device monitor, a storage monitor, a third party service monitor, among other monitors, each configured to detect various different types of sensitive data. In embodiments, ML model 212 can determine a likelihood that the detected sensitive user data is uniquely identifiable of the user by a third party.

In an embodiment, detection engine 210 in coordination with protection ML model 212 can detect interactions with external resources other than AI model 202. Accordingly, ML model 212 can identify, which, if any personal user data (e.g., files) stored on user device 206 and/or other storage (e.g. repository 216) were modified as a result of this interaction/user action.

Handling engine 214 is configured to handle sensitive data once detected by detection engine 210 (e.g. using protection ML model 212). In an embodiment, handling engine 214 is configured to instruct data management engine 208 to label unlabeled sensitive data. In an embodiment, handling engine 214 is configured to prevent storage, transfer, and/or communication of sensitive data.

In an embodiment, handling engine 214 is configured to generate modified data based on detected sensitive data. In embodiments, generating modified data includes deleting the sensitive data, modifying the sensitive data in some manner (including by metadata modification), preparing a package for storage or transmission that does not include the sensitive data, or issuing the sensitive data with a warning. In other embodiments, generating modified data for example, on image data, can include blurring one or more portions of images, replacing or blurring one or more portions of video. For example, individual faces can be blurred on individuals. In another example, car license plates can be blurred. In another embodiment, text can be replaced by dictionary definition, by translation, or by other suitable reference material. In another example, biometric data can be replaced or blurred (e.g. removing fingerprints). In another example, voice data can be replaced by distorted voice data. In another example, image data such as an individual person can be replaced by a generic image of a person or by another suitable image portion.

In an embodiment, handling engine 214 is configured to obscure or genericize sensitive data. For example, handling engine 214 can redact sensitive data in a text string such that the sensitive data is removed or otherwise obstructed. In an embodiment of sensitive data in an image, the sensitive data can be blurred in the respective portion of the image. In an embodiment, sensitive data can be replaced with generic data. For example, in an example of personal data as an address, instead of the actual address, a generic address like [123 Main Street, Anywhere, USA] can be inserted. In an embodiment, sensitive data can be issued to the user with a warning.

In an embodiment, handling engine 214 is configured with a rule set. In an embodiment, handling engine 214 is configured to generate a rule set. For example, a rule set can be predefined, generated based on user input, or generated based on other input (such as communications from external sources on jurisdictional laws or regulations).

In an embodiment, a rule set comprises a plurality of instructions to determine what data is allowable and how the data is handled (e.g. by AI model 202 in interactions with user device 206 and/or storage in data repository 216). A rule set can be preconfigured, configured by a user, or automatically generated, in certain embodiments. In an embodiment, a rule can be represented according to:

IF (booleanExpression(input data)) then
handling action(s)
ELSE next rule

In this example, input data can be data received from the user, data utilized by AI model 202, or data retrieved from data repository 216 as instructed by AI model 202. Handling action(s) can accordingly handle the input data according to the specific expression or data identified. A next rule is then executed to further handle the input data according to the next rule-specific expression. In embodiments, a rule set can handle data according to different levels of data sensitivity.

In another embodiment, handling engine 214 is configured with one or more time rules. In order to protect personal data, embodiments can be configured to handle data depending on a particular time. In an embodiment, sensitive data can be hidden before or after a time of day (e.g. “hide sensitive data before midnight, show sensitive data after midnight”). In an embodiment, sensitive data can be hidden based on its collection time (e.g. data collected before a certain time or in a certain time period is hidden).

In one example, handling actions can include instructions on how to use the data. For example, if GDPR data is identified, a handling action can handle the data according to the GDPR, such according to the GDPR minimization principle of identifying the minimum amount of personal data needed to fulfill the purpose of the request and storing that much information, but no more. For example, embodiments can filter out personal data not necessary for the user's request.

In another example, data can be identified according to a user-specific requirement. In embodiment, a handling action can handle data according to the user instruction, such as “use this data instead of my personal data.” In an embodiment, the rule set can be defined according to a previously-inputted or contemporaneously-inputted user-specific requirement. In another embodiment, the user can be subsequently presented with a request for instruction on how to handle the data identified according to the user-specific requirement.

In embodiments, handling engine 214 can be configured according to a rules definition module (not depicted in FIG. 2) as a rules engine that allows the user to define rules as to the operation of data management engine 208, detection engine 210, and/or handling engine 214. In other words, the user rules definition module allows a user to define which devices, inputs, data, etc. are tracked, which external resources are tracked, how to determine certain personal data, and now to handle such personal data, for example.

In another example, data can be identified according to a use location. In embodiment, a handling action can handle data according to the location of data operation, data transmission, or data storage. For example, in a movable user device, personal data laws or regulations can be different depending on if the user device is in a first jurisdiction or a second jurisdiction. Accordingly, rules can direct data presentation accordingly. In another example, in cloud storage, certain data nodes will physically reside in jurisdictions in which personal data laws or regulations are different from other nodes. Accordingly, rules can direct storage to certain nodes (e.g. where storage or processing is allowed according to jurisdictional laws) and not other nodes (e.g. where storage or processing is not allowed according to jurisdictional laws). Likewise, as data is transmitted, rules can direct storage across certain network connections and not other network connections.

In another example, data can be identified for use in backup storage. In an embodiment, a handling action can handle data according to a backup rule. In an embodiment, one or more tokens can be utilized in coordination with the backup rule. For example, embodiments can store or not store personal data depending on a rule that can analyze the required token. In an embodiment, handling actions can include analysis of a tokenization stream as used in a backup process.

In an embodiment, a handling action can include encrypting data for backup storage. For example, if a backup rule indicates storing personal data, the data can be encrypted such that modified user files are sent to remote data storage to be stored as backed up files.

In an embodiment, when sensitive data is withdrawn from repository 216, the sensitive data can be marked such that the responsibility of further handling of the sensitive data can be passed to further components (e.g. of the service provider). In one example, the label can be passed to subsequent system components with the sensitive data. In another example, the data can be otherwise marked, such as by digital watermarking in order to hide the sensitive data information in the carrier signal or carrier sensitive data. In another example, the data can be marked in the data of text, image, video, virtual reality, and other suitable data. In another example, the data can be marked in metadata of such data.

In an embodiment, handling engine 214 is configured with a machine learning model to handle sensitive data. More particularly, protection ML model 212 can be further trained to determine instructions on how to use the data. For example, protection ML model can utilize actual data on how sensitive data is to be handled in order to make determinations on subsequent data determined to be sensitive. In an embodiment, handling engine 214 can train an additional ML model other than protection ML model 212 to determine instructions on how to use the data. In embodiments, though depicted as separate models for ease of illustration, a single machine learning model can incorporate the structure and functionality of AI models 202, protection ML model 212, and a ML model for determining how to handle the data.

In an embodiment, a data handling policy is initially generated by an administrator user of system 200. Subsequently, an instance of system 200 can be executed on a cloud system that includes its own set of policies specific to the implementation or users. For example, a system user of the instance on the cloud system discussed can indicate to handling engine (e.g. via user device 206), “please do not store my personal data on cloud system or only in these countries.” In an embodiment in which handling engine 214 implements a machine learning model, the AI accordingly takes the initial instructions and learns that it can store data in Location X (e.g. locally), but not Location Y (cloud system or indicated countries), plus any other learnings from the machine learning model.

In an embodiment, different backup levels can be utilized. For example, a data handling policy can consider data more reliable or less reliable based on geographical location. In another example, a data handling policy can indicate that a certain backup center is desired over another backup center. In another example, a data handling policy can indicate that a transfer of data is desired to a certain backup center from another backup center.

Data repository 216 is configured to store data related to operation of AI model 202. In an embodiment, data repository 216 can include labeled data. For example, a data pair of the actual data and data corresponding to a privacy label can be stored in data repository 216. In an embodiment, the actual data and metadata can be stored in data repository 216.

In an embodiment, a log corresponding to the labels can be generated for the stored data. In an example, a separate log for each label can be generated. In another example, a log based on each user can be generated (e.g. associated with that user's personal data). In another example, a log based on the entire AI model 202 can be generated. In an embodiment, any of the labels or logs created can be hashed for additional security. In an embodiment, data management engine 208, detection engine 210, protection ML model 212, and/or handling engine 214 can selectively have access to the log for algorithm improvement, storing and sensing on-demand, and other operations described herein.

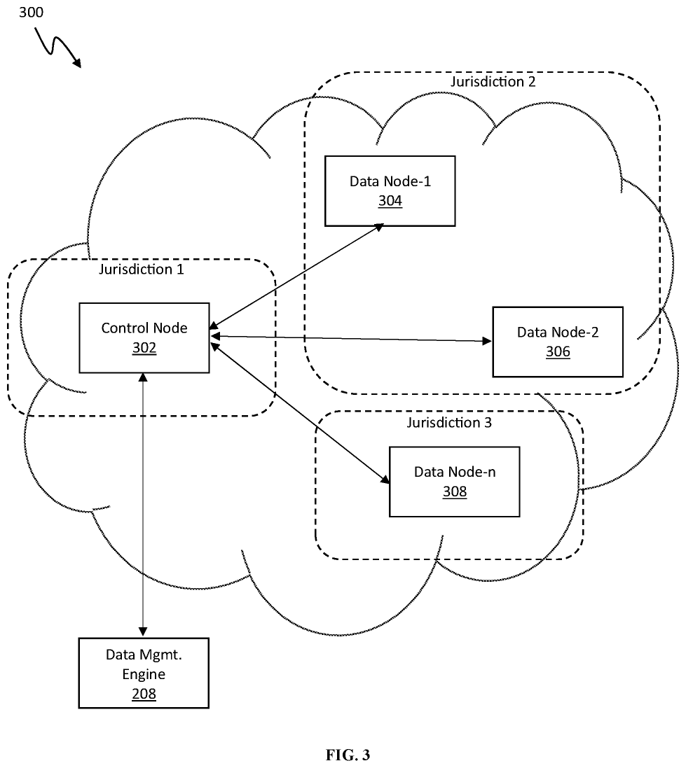

In embodiments, though not depicted, data repository 216 can include unlabeled data, as will be further described with respect to FIG. 3. In an embodiment, data repository 216 can be data repository 108.

In one embodiment, data repository 216 can be physical storage such as local storage or file storage on fixed or portable computing device. In another embodiment, data repository 216 can be cloud-based storage including a plurality of storage nodes.

In an embodiment, data can be split. For example, the flow of data (TXT text file, MP3 audio file, etc.) can be split into a plurality of data sections. A first section can include a label and a second section can be unlabeled. In other embodiments, the data can be dynamically split or obfuscated based on masking.

FIG. 3 is a block diagram of cloud storage 300 across multiple physical jurisdictions, according to an embodiment. In an embodiment, cloud storage 300 generally comprises a control node 302 and a plurality of data nodes, such as data node-1 304, data node-2 306, and data node-n 308. As illustrated, control node 302 physically resides in a first jurisdiction (Jurisdiction 1). Data node-1 304 and data node-2 306 physically reside in a second jurisdiction (Jurisdiction 2). Data node-n 308 physically resides in a third jurisdiction (Jurisdiction 3).

Consider an example in which certain personal data is allowed (e.g. by local jurisdictional rule or order) to be stored or operated on in Jurisdiction 1 and Jurisdiction 2 but not Jurisdiction 3. Accordingly, data management engine 208 can instruct control node 302, as instructed by handling engine 214, for storage on certain data nodes, and restrict others. In an embodiment, control node 302 can provide data management engine 208 a network map of the cloud storage, including jurisdictional storage locations. For example, a network map is a visual representation of devices in the network, their interconnections, and the transport layers that provide network services. The network map can include relative locations such as physical location name, identifier, IP address, etc. Data management engine 208 can accordingly utilize the network map (as instructed by handling engine 214) to instruct storage on data node-1 304 and data node-2 306 and not data node-n 308.

In an embodiment, data movement between data centers can be restricted. For example, a backup optimization can identify proper data placement (such as by IP address, load balancing, etc.). In a particular example, data on data node-1 304 is not moved to data-node-2 306 due to an improper load on data-node-2 306.

Similarly, personal data can be allowed or not allowed on device storage. Storage can be extended to local algorithm applications such as ChatGPT and backups, that is, partially local partially illegal services (head in the cloud, context update now 4k or 32k items for chatgpt4) calls, including logs. In embodiments, personal data can be allowed or not allowed according to physical storage location. In embodiments, personal data can be allowed or not allowed according to potential physical location (e.g. data is currently local but will be transferred to a remote database).

Accordingly, data management engine 208 can handle cloud storage and local storage differently. For example, in an embodiment, as instructed by handling engine 214, personal data can be stored on local storage, but not on cloud storage. In another example of a portable computing device, in an embodiment, as instructed by handling engine 214, storage may be allowed by local rule in a first physical location in which the computing device is located, but not allowed by local rule in a second physical location in which the computing device is located. Data protection sub-system 204 can therefore request or obtain a location of user device 206 (e.g. network protocol such as IP address) as an input to handling engine 214.

In an embodiment, handling engine 214 can be dynamically updated to account for changes in cloud storage. For example, data management engine 208 can request updated network maps of control node 302 at certain intervals, such as every 1 second, 1 minute, 1 hour, 1 day, etc. Other intervals or frequencies are also considered.

In an embodiment, data management engine 208 can compare network maps to detect changes in cross-border circuits and communicate the changes to handling engine 214 for updated handling procedures. In an embodiment, handling engine 214 can be dynamically updated to account for changes in jurisdiction orders. For example, handling engine 214 can communicate with one or more network devices (not depicted in FIGS. 2-3) to request and receive updates to jurisdictional orders. Handling engine 214 can accordingly update its handling instructions.

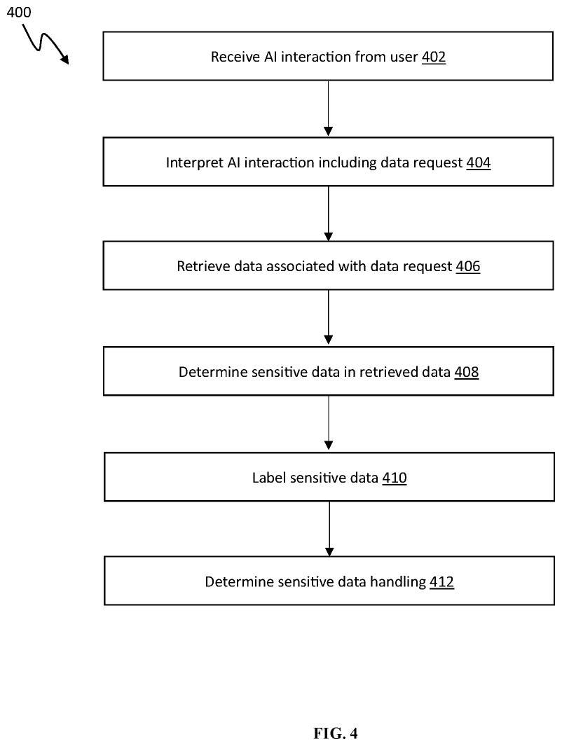

Referring to FIG. 4, a flowchart of a method 400 for protecting data used by an AI model is depicted, according to an embodiment. Method 400 can be implemented by system 100 or system 200. Further reference is made herein to system 200. For example, method 300 can be executed in operation of system 200.

At 402, an AI interaction is received from a user. For example, a user operating user device 206 can interact with AI model 202.

At 404, the AI interaction is interpreted. For example, AI model 202, using its LLM (e.g. LLM 106) can interpret the user interactions to determine a data request made by the user.

At 406, data associated with the data request is retrieved. For example, AI model 202 can request that data management engine 208 retrieve certain data in repository 216.

At 408, sensitive data is determined to be in the retrieved data. For example, detection engine 210, using protection ML model 212, can determine that sensitive data is in the retrieved data from repository 216. In an embodiment, a type of data is determined for all or one or more portions of the retrieved data.

At 410, the sensitive data is labeled. For example, data management engine 208 can label the entire data or portions of the data as sensitive. In one example, data management engine 208 can generate a log to reflect the data (or, in embodiments, a pointer to the data) and its associated label.

At 412, use of the sensitive data, now labeled, is determined. For example, handling engine 214 can determine how to store, present, transmit, or otherwise operate on the sensitive data. More particularly, handling engine 214 can utilize one or more rules, a ML model, or present the user with one or more questions on how to handle the data. In an embodiment, the sensitive data is not stored. In an embodiment, the sensitive data is stored with a label indicating sensitive data. In an embodiment, the sensitive data is genericized. In an embodiment, the sensitive data can be issued to the user with a warning about its use. In further embodiments, along with alerting the user about the use of sensitive data, the sensitive data can be stored locally with the user device and not in external or cloud-based storage.

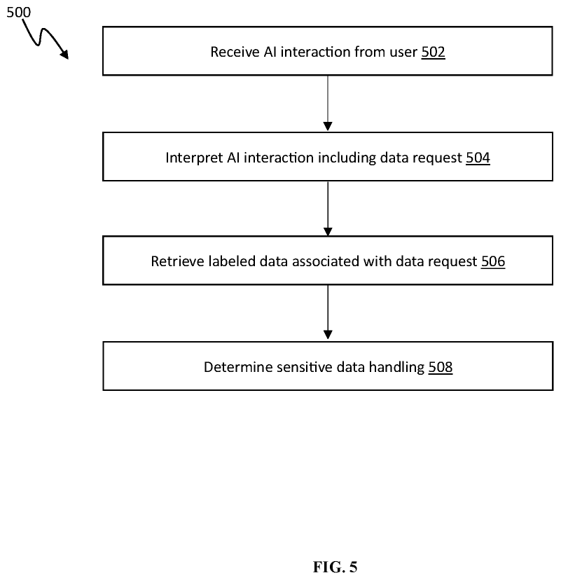

Referring to FIG. 5, a flowchart of a method 500 for protecting data used by an AI model, according to an embodiment. Method 500 can be implemented by system 100 or system 200. Further reference is made herein to system 200. For example, method 500 can be executed in operation of system 200. More particularly, method 500 can be executed on data that is previously labeled in repository 216.

At 502, an AI interaction is received from a user. For example, a user operating user device 206 can interact with AI model 202.

At 504, the AI interaction is interpreted. For example, AI model 202, using its LLM (e.g. LLM 106) can interpret the user interactions to determine a data request made by the user.

At 506, data associated with the data request is retrieved. For example, AI model 202 can request that data management engine 208 retrieve certain data in repository 216.

At 508, use of the previously-labeled sensitive data is determined. For example, handling engine 214 can determine how to store, present, transmit, or otherwise operate on the sensitive data. More particularly, handling engine 214 can apply one or more rules for data handling. In embodiments, handling engine 214 can utilize a ML model for data handling. In embodiments, handling engine 214 can present the user with one or more questions on how to handle the data. In an embodiment, the sensitive data is not stored. In an embodiment, the sensitive data is genericized. In an embodiment, the sensitive data can be issued to the user with a warning about its use.

1. A method for protecting sensitive data, the method comprising:
generating a rule set for handling sensitive data;
receiving, via a natural language processing tool, a request from a user;
retrieving data associated with the request, wherein the data includes at least one of text data, image data, video data, audio data, virtual reality data, or gesture data;
determining a sensitive data portion of the data;
labeling the sensitive data portion of the data;
operating on the sensitive data portion according to the rule set based on the labeling to generate modified data; and
returning the modified data to the user.

2. The method of claim 1, wherein operating on the sensitive data portion includes deleting the sensitive data portion, the method further comprising storing the data without the sensitive data portion.

3. The method of claim 1, wherein operating on the sensitive data portion includes replacing the sensitive data portion with generic data.

4. The method of claim 1, wherein the request includes handling instructions for the sensitive data portion, and wherein operating on the sensitive data portion includes executing the handling instructions according to the rule set.

5. The method of claim 4, the method further comprising:
presenting a response interface to the user, the response interface including a prompt for the handling instructions; and
receiving the handling instructions via the response interface.

6. The method of claim 1, further comprising detecting a location associated with the request, wherein the rule set includes a location-based handling instruction, and wherein the location associated with the request includes a user location or a data storage location.

7. The method of claim 6, wherein the data storage location is a cloud storage including a plurality of storage nodes, wherein the location-based handling instruction includes allowing storage on a first storage node in the plurality of storage nodes and preventing storage on a second storage node in the plurality of storage nodes.

8. The method of claim 1, wherein determining the sensitive data portion of the data includes at least one of:
applying a machine learning model trained on a training data of a plurality of previous requests including a plurality of previous sensitive data,
reading a previous label for the data indicating the sensitive data portion, or
receiving input of the sensitive data portion from a user.

9. The method of claim 8, further comprising:
retraining the machine learning model using the sensitive data portion and the labeling.

10. The method of claim 1, further comprising:
receiving, via the natural language processing tool, a data retrieval request from the user;
retrieving previously-labeled sensitive data associated with the data retrieval request; and
returning the previously-labeled sensitive data to the user according to the rule set based on the label of the previously-labeled sensitive data.

11. The method of claim 1, wherein returning the modified data to the user includes issuing the sensitive data to the user with a warning of sensitive data use.

12. A system for protecting sensitive data, the system comprising:
computing hardware of at least one processor and memory operably coupled to the at least one processor; and
instructions that, when executed on the computing hardware, cause the computing hardware to implement:
a natural language processing tool configured to receive a request from a user,
a data management engine configured to retrieve data associated with the request and label sensitive data portion of the data, wherein the data includes at least one of text data, image data, video data, audio data, virtual reality data, or gesture data,
a detection engine configured to determine a sensitive data portion of the data,
a handling engine configured to generate a rule set and operate on the sensitive data portion according to the rule set based on the labeling to generate modified data, and
wherein the natural language processing tool is further configured to return the modified data to the user.

13. The system of claim 12, wherein the handling engine is configured to operate on the sensitive data portion including by deleting the sensitive data portion, wherein the data management engine is further configured to store the data without the sensitive data portion.

14. The system of claim 12, wherein the natural language processing tool is further configured to:
present a response interface to the user, the response interface including a prompt for the handling instructions; and
receive the handling instructions via the response interface.

15. The system of claim 12, wherein the handling engine is configured to operate on the sensitive data portion by detecting a location associated with the request, wherein the rule set includes a location-based handling instruction, and wherein the location associated with the request includes a user location or a data storage location.

16. The system of claim 15, further comprising:
a cloud storage including a plurality of storage nodes,
wherein the location-based handling instruction includes allowing storage on a first storage node in the plurality of storage nodes and preventing storage on a second storage node in the plurality of storage nodes.

17. The system of claim 12, wherein the detection engine is configured to determine the sensitive data portion of the data including at least one of:
applying a machine learning model trained on a training data of a plurality of previous requests including a plurality of previous sensitive data,
reading a previous label for the data indicating the sensitive data portion, or
receiving input of the sensitive data portion from a user.

18. The system of claim 17, wherein the detection engine is further configured to retrain the machine learning model using the sensitive data portion and the labeling.

19. The system of claim 12, wherein returning the modified data to the user includes issuing the sensitive data to the user with a warning of sensitive data use.

20. A machine learning model trained on training data of a plurality of previous natural language requests including a plurality of previous sensitive data, the machine learning model configured to:
receive a natural language request from a user;
determine data associated with the request;
determine a sensitive data portion of the data;
determine a handling instruction for the sensitive data portion; and
return the sensitive data portion to the user according to the handling instruction.
